(19) United States
(12) Patent Application Publication
(10) Pub. No.: US 2003/0107296 A1
(43) Pub. Date: Jun. 12, 2003

(54) Lever mechanism for increasing displacement of micro-actuating device

(75) Inventor: Woo-Sup Han, Kyungki-do (KR)

Correspondence Address: BURNS DOANE SWECKER & MATHIS L L P, POST OFFICE BOX 1404, ALEXANDRIA, VA, 22313-1404, US

(73) Assignee: Samsung Electronics Co., Ltd., Kyungki-do (KR)

(21) Appl. No.: 10/246,418

(22) Filed: Sep. 19, 2002

(30) Foreign Application Priority Data
Dec. 12, 2001 (KR) 2001-78672

(51) Int. Cl. H02N 1/00

(52) U.S. Cl. 310/309

(57) ABSTRACT

A lever mechanism for increasing the displacement of a micro-actuating device is provided. The lever mechanism includes a power generator for generating power in a predetermined direction, a first power transmitter for transmitting the power generated by the power generator to a micro-actuating device, a second power transmitter for transmitting the power transmitted by the first power transmitter, a micro-actuating device that is connected to the second power transmitter and moves to have larger displacement than the displacement of the first power transmitter; and at least one hinge installed among the power generator, the first power transmitter, the second power transmitter, and the micro-actuating device. According to this lever mechanism, it is possible to largely increase the kinetic range of a micro-actuating device by slightly change the displacement thereof.

### CROSS-REFERENCE TO RELATED APPLICATIONS

This application is based upon and claims priority from Korean Patent Application No. 2001-78672 filed Dec. 12, 2001, the contents of which are incorporated herein by reference.

### BACKGROUND OF THE INVENTION

1. Field of the Invention

The present invention relates to a lever mechanism for increasing the displacement of subminiature micro-actuating devices, and more particularly, a lever mechanism for largely increasing the kinetic range of a micro-actuating device by slightly changing the displacement thereof.

2. Description of the Related Art

Hereinafter, a conventional data storage apparatus will be described with reference to FIGS. 1A and 1B. Referring to FIG. 1A, comb electrodes 13, which causes the displacement of a media 11, are each formed along the sidewalls of a planar substrate on which a media having data storage means is placed. On the media 11 are fixed probes 12 for storing/reproducing data in/from the media 11. The comb electrodes 13 keep the media 11 a predetermined distance away from the probes 12. At this time, the media 11 moves due to an electrostatic force generated by the comb electrodes 13, and the displacement of the media 11 changes within the range of the displacement of the comb electrodes 13.

FIG. 1B is a perspective view of the structure of the media 11 and the comb electrode 13 for actuating the media 11. Referring to FIG. 1B, a device to be actuated, i.e., the media 11, is formed on a planar substrate, and the comb electrodes 13 are formed along the sidewalls of the media 11. Here, each comb electrode 13 moves the media 11 to have a predetermined displacement by an electrostatic force. Due to the electrostatic force generated by the comb electrodes 13, the media 11 moves linearly, and linear motions of the media 11 in two different directions combine to make the media 11 move in a diagonal direction. In this disclosure, the media 11, which is one of micro-actuating devices, is described to be actuated by an electrostatic force, but it may be actuated by a magnetic force, a piezoelectric force and so on. However, these forces are not enough to sufficiently actuate the micro-actuating device, and further, the moving distance of the media 11 is limited to a distance among electrodes. As a result, there is a limitation in increasing the displacement of the media 11. For this reason, a lot of probes are required for more effectively using a micro-actuating device as illustrated in FIGS. 1A and 1B, i.e., the media 11, thereby increasing manufacturing cost. Also, it is difficult to transmit/receive data to/from a data storage apparatus, and distribute wires.

### SUMMARY OF THE INVENTION

To solve the above-described problems, it is an object of the present invention to provide a lever mechanism that is capable of controlling the kinetic range of a micro-actuating device minutely as far as possible by increasing the kinetic range with a slight change in the displacement of the micro-actuating device. Accordingly, to achieve an aspect of the above object, there is provided a lever mechanism for increasing the displacement of a micro-actuating system, the lever mechanism including a power generator for generating power in a predetermined direction; a first power transmitter for transmitting the power generated by the power generator to a micro-actuating device; a second power transmitter for transmitting the power transmitted by the first power transmitter; a micro-actuating device connected to the second power transmitter, the micro-actuating device moving to have larger displacement than the displacement of the first power transmitter; and at least one hinge installed among the power generator, the first power transmitter, the second power transmitter, and the micro-actuating device.

The first power transmitter has one end connected to the second power transmitter and, the opposite end connected to a fixed unit, the displacement of the one end is larger than the displacement of the opposite end when the first power transmitter transmits power generated by the power generator while being connected to the power generator between the center of the first power transmitter and the fixed unit, which is connected to the opposite end.

The second power transmitter has one end connected to the fixed unit, and the opposite end connected to the micro-actuating device, the displacement of one end, which is connected to the first power transmitter, is larger than the displacement of the opposite end when the second power transmitter transmits power transmitted from the first power generator while being connected to the first power transmitter between the center of the second power transmitter and the opposite end.

The hinge makes an elastic knuckle joint motion. The power generator generates power by an electrostatic force, a magnetic force or a piezoelectric force.

The lever mechanism further includes levers installed between the first and second power transmitters, the levers for helping the smooth operations of the first and second power transmitters. The lever mechanism also further includes levers installed between the second power transmitter and the micro-actuating device, the levers for helping the smooth operations of the second power transmitter and the micro-actuating device.

To achieve another aspect of the above object, there is provided a lever mechanism for increasing the displacement of a micro-actuating device, the lever mechanism including a media for recording and reproducing data, at least one second power transmitter connected to two edges of one side and opposite side of the media, at least one first power transmitter for transmitting power to the second power transmitter(s), power generators for generating power to be transmitted to the first power transmitter(s) in a predetermined direction, and at least one hinge installed among the power generators, the first and second power transmitters, and the media.

Here, the hinge makes an elastic knuckle joint motion.

The displacements of the hinges and the first and second levers are increased due to their resonance movement.

The lever mechanism further includes a first lever installed between the first power transmitter and the second power transmitter, the first lever for helping the smooth operations of the first and second power transmitters.

### BRIEF DESCRIPTION OF THE DRAWINGS

The above objects and advantages of the present invention will become more apparent by describing in detail a preferred embodiment thereof with reference to the attached drawings in which:

FIGS. 1A and 1B are views of the structure of a conventional system for actuating micro-actuating devices;

FIGS. 2A and 2B are views for explaining a lever mechanism-for increasing the displacement of a micro-actuating device according to the present invention;

FIGS. 3A and 3B are views of a lever mechanism applied to a micro actuating device according to the present invention;

FIG. 4A is a view of a lever mechanism, according to the present invention, applied to a compact storage system actuated by comb;

FIG. 4B is a view for explaining the functions of a lever included in the lever mechanism of FIG. 4A; and

FIGS. 5A through 5D are views of a lever mechanism applied to a probe of a compact storage system according to the present invention.

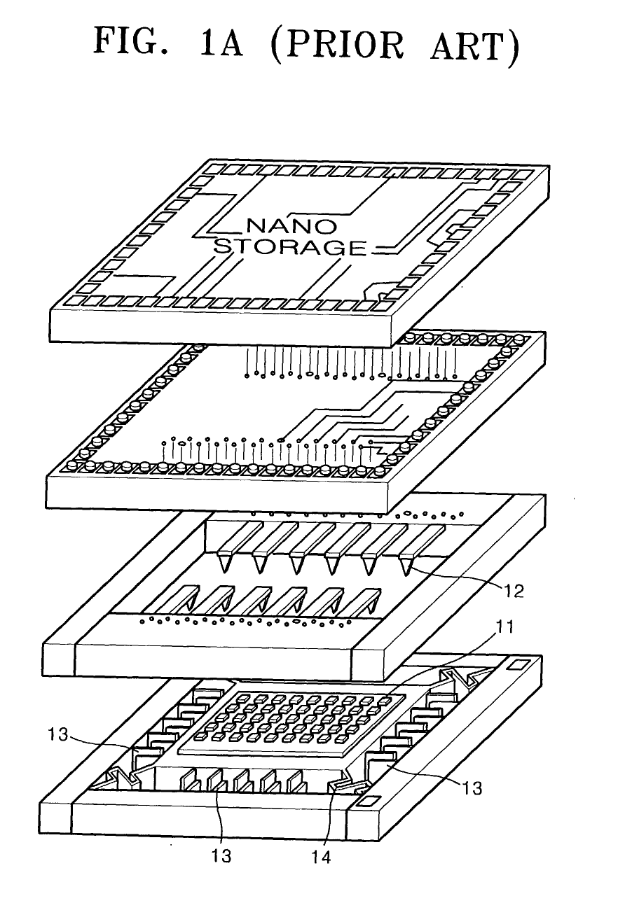

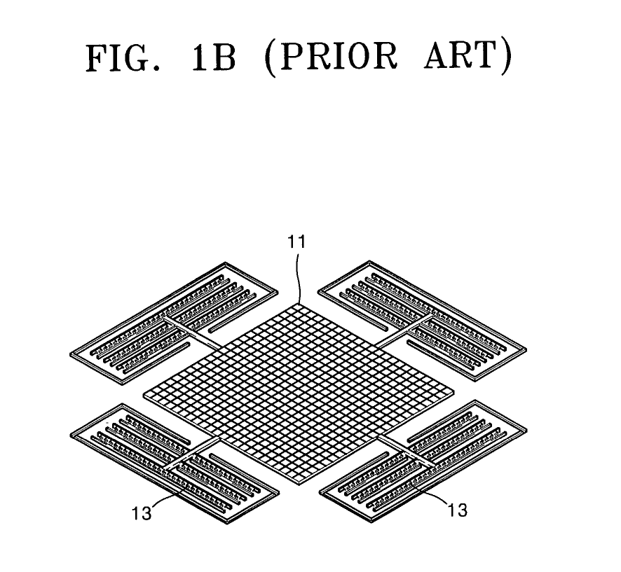

### DETAILED DESCRIPTION OF,THE INVENTION

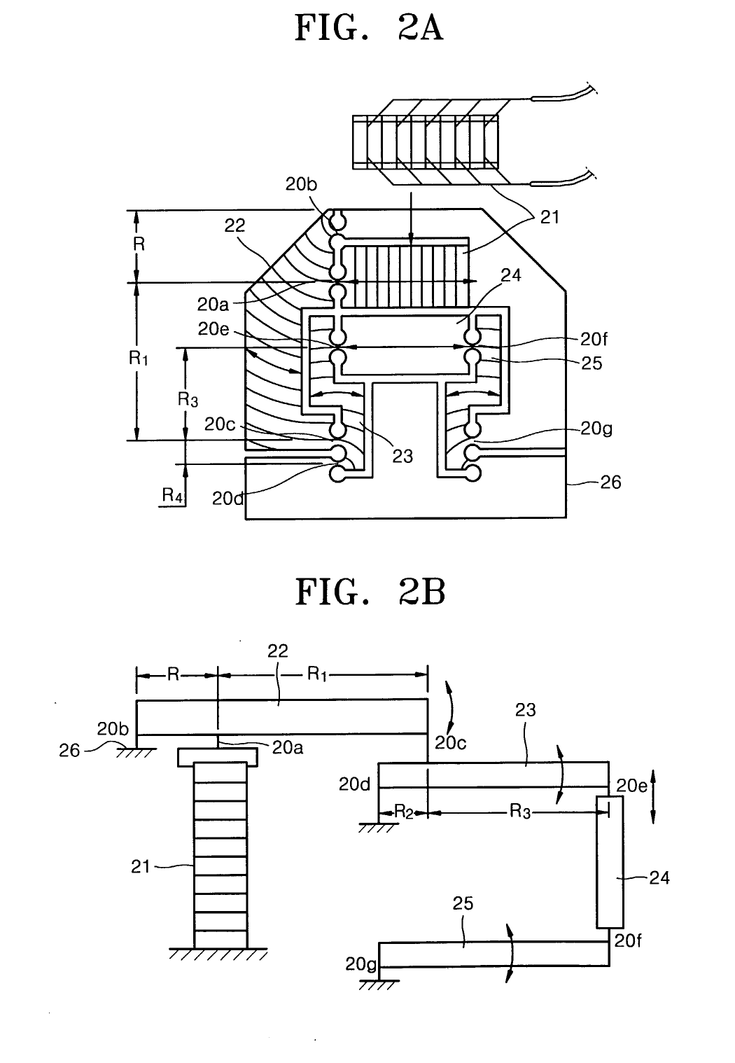

Hereinafter, a lever mechanism for increasing the displacement of a micro-actuating device, according to the present invention, will be described with reference to FIGS. 2A and 2B. In this disclosure, the general leverage is applied to a system for actuating micro actuating devices so as to increase the displacement of a micro actuating device.

Referring to FIG. 2A, a target 24 denotes an object to be actuated, and a power generator 21 denotes a device for generating power to induce the movement of the target 24. Here, the type of power generated by the power generator 21 is not restricted, thus, the power may be, for example, an electrostatic force, an electromagnetic force, or a piezoelectric force. Between the power generator 21 and the target 24 are installed a plurality of power transmitters 22 and 23, hinges 20a through 20g. The power transmitters 22 and 23, and the hinges 20a through 20g transmit power generated by the power generator 21 to the target 24, and further determine the direction of the movement of the target 24. Preferably, the power transmitters 22 and 23, and the hinges 20a through 20g are formed of an elastic material. The power generator 21 is connected to the first power transmitters 22 via the hinge 20a. The first power transmitter 22 is connected to a fixed unit 26 via the hinge 20b, and is also connected to the second power transmitter 23 via the hinge 20c. The second power transmitter 23 is connected to the fixed unit 26 and the target 24 to via the hinge 20d and the hinge 20e, respectively. The target 24 is also connected to a holder 25, in addition to the second power transmitter 23, via the hinge 20f. The holder 25 is connected to the fixed unit 26 via the hinge 20g.

In conclusion, the target 24 makes a motion the first and second power transmitters 22 and 23, being connected to the power generator 21 and supported by the holder 25. The power transmitters 22 and 23, and the holder 25 balance themselves, being connected to the fixed unit 26. Here, all connections are made of the hinges 20a through 20g which may move elastically, respectively.

In the operations of the above lever mechanism, the hinge 20a is given power generated by the power generator 21 to moves in one direction. Then, the first power transmitter 22 receives the power from the power generator via the hinge 20a, and moves in the same direction of the movement of the hinge 20a. At this time, the leverage is applied between the hinge 20a and the hinge 20b. As a result, the displacement of one end of the first power transmitter 22, which is connected with the hinge 20c, becomes larger than that of another end of the first power transmitter 22 connected to the hinge 20b. Further, the hinges 20c and 20d, which are connected to the first power transmitter 22, transmit the power transmitted from the first power transmitter 22 to the second power transmitter 23 while making an elastic knuckle joint motion. Here, the leverage is also applied between the hinge 20c and the hinge 20d. Also, the displacement of one end of the second power transmitter 23, which is connected to the hinge 20e, is larger than that of another end thereof connected to the hinge 20e. Therefore, the target 24 moves having the greater displacement than the hinge 20a connected to the power generator 21. Here, the target 24 is connected to the holder 25 via the hinge 20f, and the holder 25 is connected to the fixed unit 26 via the hinge 20g. Thus, the leverage is applied between the hinge 20g and the hinge 20f. For this reason, the target 24 can move in one direction having larger displacement than the power generator 21.

For better understanding, a lever mechanism for increasing the displacement according to the present invention will now be described in detail with reference to FIG. 2B. Here, components that are the same as those of FIG. 2A will be described with the same numbers, and explanations thereof will be omitted for convenience.

When the power generator 21 generates power and makes a linear motion in one direction, the hinge 20c, which is connected to one end of the first power generator 22, moves to have relatively large displacement than the hinge 20a. At this time, the hinge 20b functions as a rotating axis, and the rotating displacement of one end of the first power transmitter 22, which is connected to the hinge 20c, changes according to the ratio of a distance R between the hinge 20a and the hinge 20b, and a distance R1 between the hinge 20a and the hinge 20c. In other words, the distance R1 is larger than the distance R, allowing the displacement of the hinge 20c to be larger than that of the hinge 20a. Therefore, the motion of the first power transmitter 22 results in the movement of the second power transmitter 23, which is connected to the first power transmitter 22 via the hinge 20c.

Since the second power transmitter 23 is connected to the fixed unit 26 via the hinge 20d, the hinge 20d functions as a rotating axis. Here, the leverage is applied such that the displacement of one end of the second power transmitter 23 is increased according to the ratio of a distance R2 between the hinge 20c and the hinge 20d, and a distance R3 between the hinge 20c and the hinge 20e. The hinge 20e is connected to the target 24, and the target 24 is connected to the holder 25 whose shape is similar to the second power transmitter 23 via the hinge 20f. Also, the holder 25 is connected to the fixed unit 26 via the hinge 20g.

Therefore, if power is transmitted from the second power transmitter 23 to the target 24, the target 24 makes a motion with the relatively large displacement than that of the hinge 20a moving by the power generator 21.

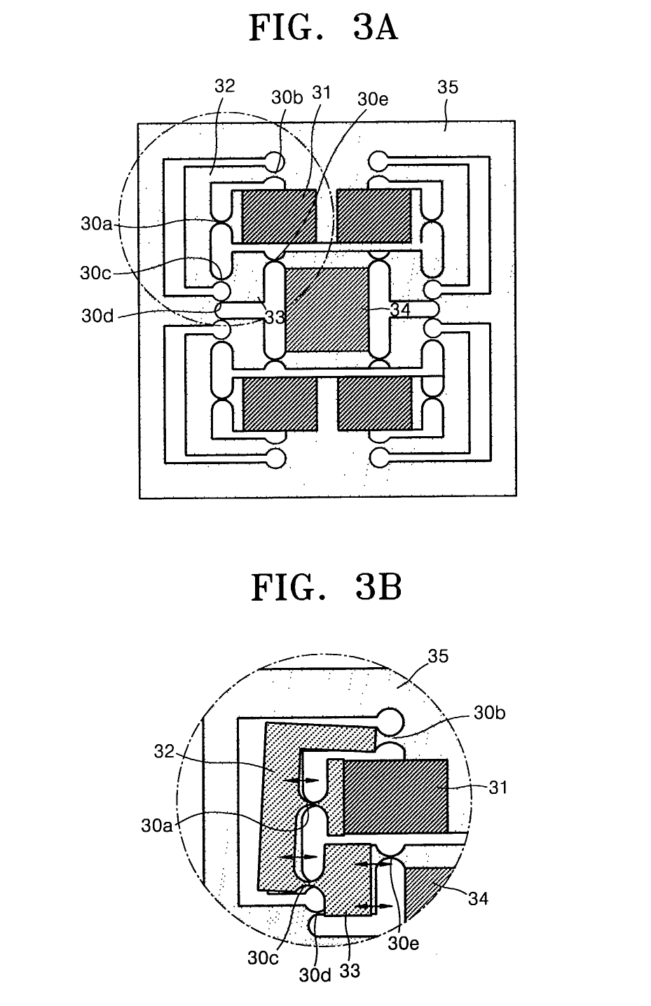

FIGS. 3A and 3B are views of a lever mechanism for increasing the displacement of a micro-actuating device, according to the present invention, applied to a data storage apparatus. Here, FIG. 3A is a plan view of the data storage apparatus, and FIG. 3B is an enlarged view of a portion of the lever mechanism of FIG. 3A.

More specifically, FIG. 3A is a view of a data storage apparatus allowing a target to be actuated, with a large displacement, on a plane by a small amount of power in the horizontal direction,. Referring to FIG. 3A, a frame 35, which is a fixed unit, includes a power generator 31, hinges 30a through 30e, power transmitters 32 and 33, and a media 34. The power generator 31 generates power such as an electrostatic force, a magnetic force, and a piezoelectric force, being connected to the first power transmitter 32 via the hinge 30a. In each lever mechanism, one end of the first power transmitter 32 is connected to the frame 35 via the hinge 30b, and its opposite end is connected to the second power transmitter 33 via the hinge 30c. One end of the second power transmitter 33 is connected to the frame 35 via the hinge 30d, and its opposite end is connected to the media 34 via the hinge 30e. Such lever mechanisms are installed at the corners of the both sides of the media 34, respectively.

The media 34 of the above data storage apparatus is also moved according to the leverage explained with reference to FIGS. 2A and 2B. That is, the power generator 31 generates power, for example, an electrostatic force, a magnetic force or a piezoelectric force, to make the hinge 30a move. As a result, the power is transmitted to the media 34 via the first and second power transmitters 32 and 33 and the hinges 30c and 30e, and the displacement of the media 34 becomes greater than that of the hinge 30a according to the leverage. Here, the media 34 includes lever mechanisms having the same structures at its both side, and thus the media 34 can move a linear motion on a plane.

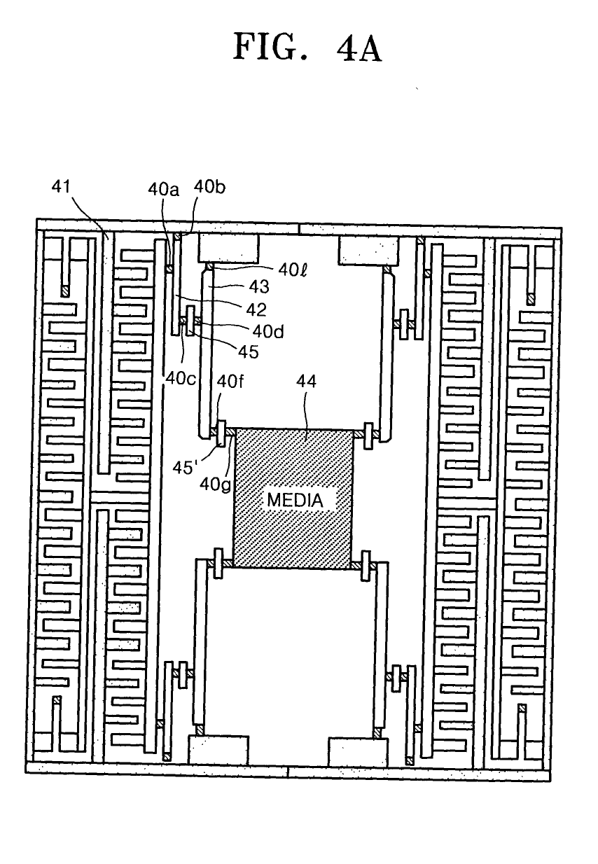

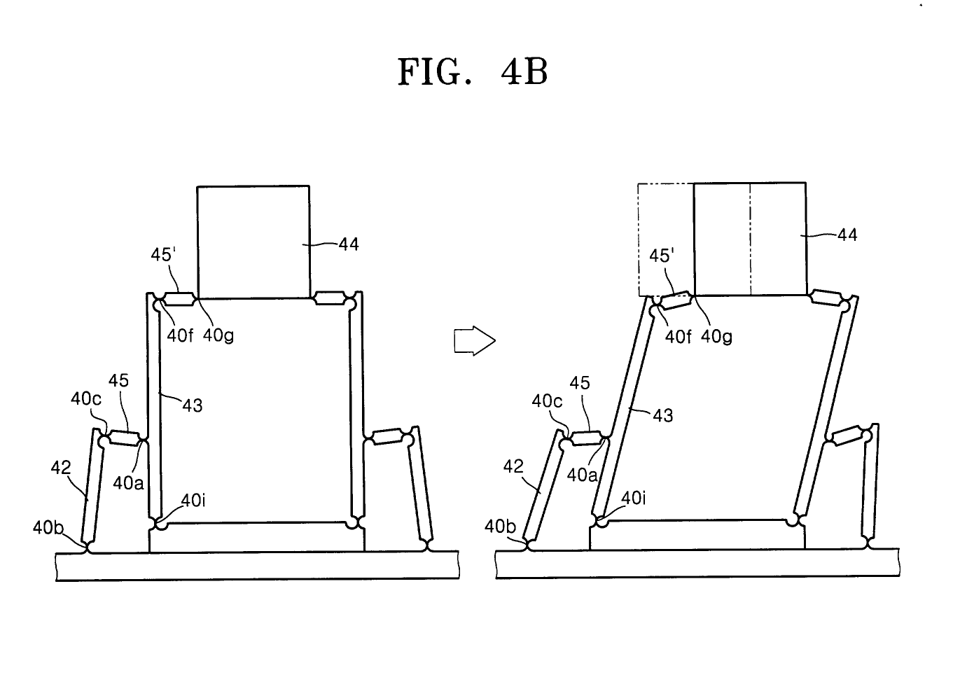

FIG. 4A is a view of a lever mechanism for increasing the displacement of a micro-actuating device, according to the present invention, combined with a conventional micro media 44. Referring to FIG. 4A, comb electrodes 41 function as a power generator for moving power the media 44, and the media 44 is actuated directly by the lever mechanism according to the present invention. If the comb electrodes 41 generate power to move the media 44, the media 44 is actuated by the lever mechanism according to the present invention, having relatively larger displacement than the comb electrodes 41, and is moved to a predetermined position. To help the operations of the second transmitter 43 and the media 44, levers 45 and 45′ are installed between the first and second power transmitter 42 and 43. Accordingly, the media 44 makes a motion on a plane in one direction. In this case, preferably, probes (not shown), which scans the media 44, i.e., records/reproduces information on/from the media 44, is installed to move in the different direction of the displacement of the media 44 on a plane. For instance, the probes may be installed on the media 44 such that the probes move in the vertical direction of the movement of the media 44 on a plane.

FIG. 4B is a view explaining the functions of levers for increasing the displacement,of a media 44, installed in the lever mechanism of FIG. 4A. Referring to FIG. 4B, when a force is given in one direction of the first and second power transmitters 42 and 43, e.g., in the left direction, the media 44 moves in the opposite direction, i.e., in the right direction. At this time, during transferring the force from the first power transmitter 43 to the media 44, the displacement of the media 44 is increased. Further, the installation of the levers 45 and 45′, although the displacement of the media 44, which is a target to be actuated, is rapidly increased, the media 44 can be smoothly moved in a desired direction. In other words, the range of the displacement of the media 44 is to be restricted within narrow limits unless the levers 45 and 45′ are installed between the first and second power transmitters 42 and 43, and between the second power transmitter 43 and the media 44.

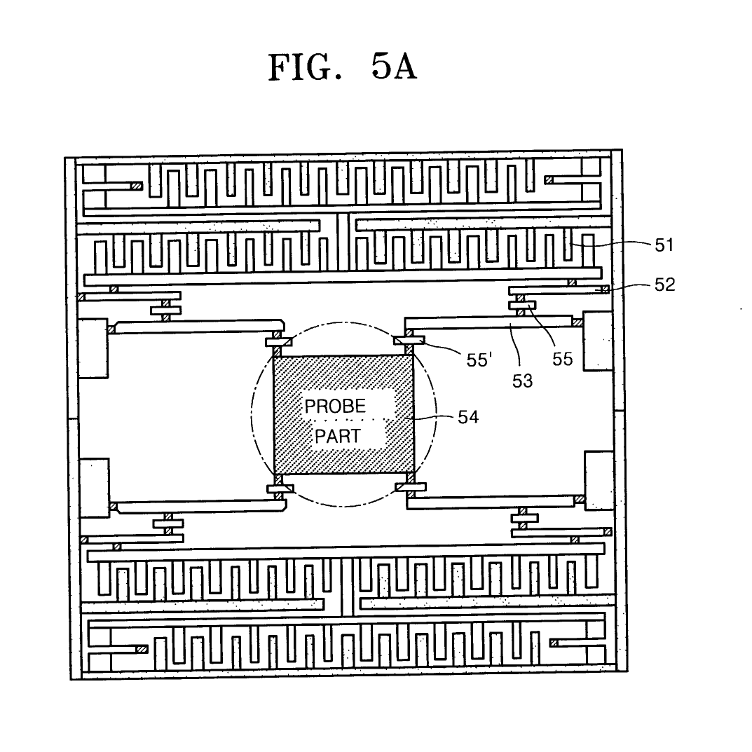

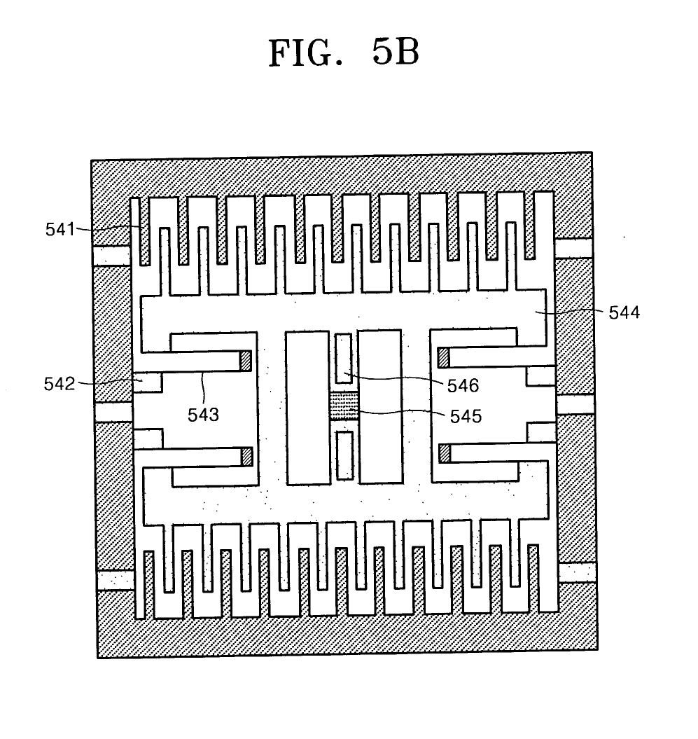

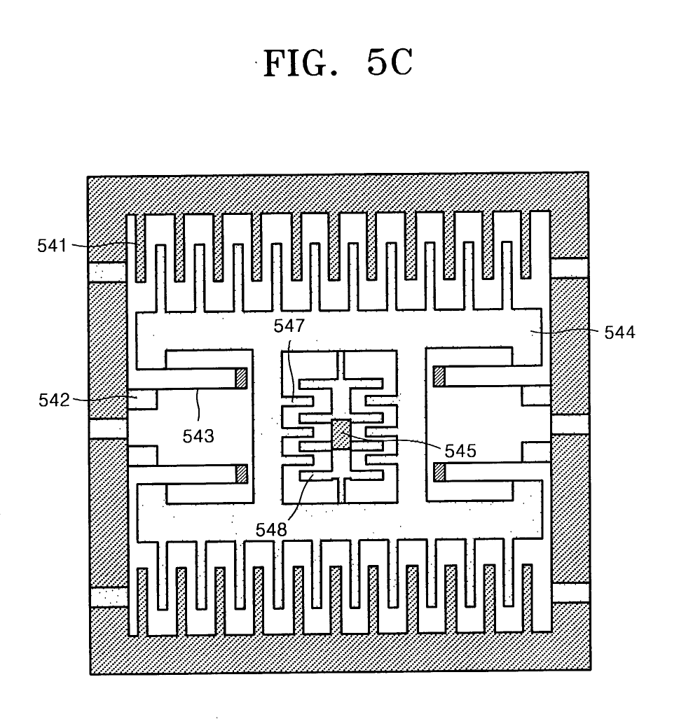

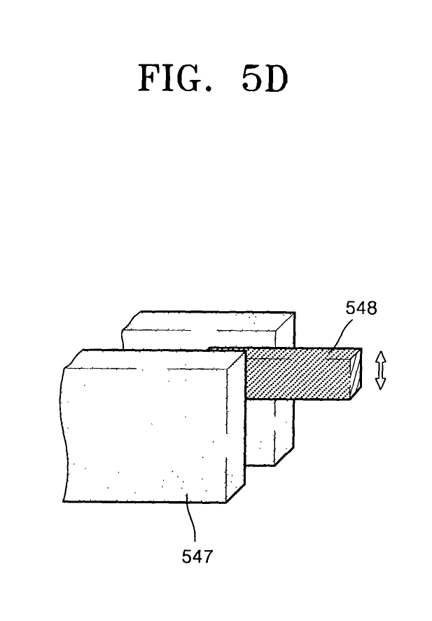

FIGS. 5A through 5D are views of a lever mechanism applied to a probe of a compact storage system according to the present invention. This lever mechanism is installed to move the probe part 54 in the vertical direction, whereas the lever mechanism of FIGS. 3A and 3B is installed to move the media 34 in the horizontal direction. The structure of the lever mechanism of FIG. 5A is the same as that of the lever mechanism of FIG. 4A. That is, comb electrodes 51 generate and transmit power to first and second power transmitters 52 and 53, and increase the displacement of the probe part 54. Also, levers 55 and 55′ are installed between the first and second power transmitters 52 and 53, and between the second power transmitter 53 and the probe part 54, so as to help the smooth movement thereof.

As shown in FIG. 5B, the probe part 54 of FIG. 5A has the same structure of a conventional comb electrode so that it can be more precisely controlled by the system of FIG. 5B due to the levers 55 and 55′ of FIG. 5A, and includes fixed poles 542, elastic elements 543, and a moving plate 544. The probe part 545, which records or reproduces data, can move upward and downward due to piezoelectric bodies 546 installed at the both sides of the probe part 545, thereby adjusting a distance between the media (not shown) and the probe part 545. Thus if a lever mechanism for increasing the displacement of a micro-actuating device is fabricated as illustrated in FIGS. 5A and 5B, a target to be actuated, i.e., a micro-actuating device, can be moved in both directions such as a horizontal direction and a vertical direction.

Also, as shown in FIGS. 5C and 5D, stator comb electrodes 547 and a rotor comb electrode 548 may take the place of the piezoelectric body 546 of FIG. 5B, so that the probe part 545 moves on the probe part 54 of FIG. 5A upward and downward. Therefore, if a lever mechanism for increasing the displacement of a micro-actuating device according to the present invention is combined with a conventional one, a micro-actuating device can make two-dimensional or three-dimensional motion. Also, according to the present invention, it is possible to provide a lever mechanism of increasing the displacement of a micro device as far as possible using the resonance characteristics of levers and hinges, based on a fact that the displacement of a micro device can be increased using the elastic deformation of a hinge.

While this invention has been particularly shown and described with reference to preferred embodiments thereof, it will be understood by those skilled in the art that various changes in form and details may be made therein without departing from the spirit and scope of the invention as defined by the appended claims.

According to the present invention, it is possible to easily increase the displacement of elements in the micro unit. For instance, with a lever mechanism for increasing the displacement of a micro-actuating device, it is possible to remarkably reduce the numbers of expensive probes, such as a head, required in a data storage apparatus, and to simplify the structure of an interconnection in comparison with the prior art. Also, this mechanism does require less precision than the prior art. According to the present invention, it is possible to actuate a resonant driving apparatus by a small quantity of power, thereby sparing expenses.

What is claimed is:

1. A lever mechanism for increasing the displacement of a micro-actuating device, the lever mechanism comprising:
a power generator for generating power in a predetermined direction;
a first power transmitter for transmitting the power generated by the power generator to a micro-actuating device;
a second power transmitter for transmitting the power transmitted by the first power transmitter;
a micro-actuating device connected to the second power transmitter, the micro-actuating device moving to have larger displacement than the displacement of the first power transmitter; and
at least one hinge installed among the power generator, the first power transmitter, the second power transmitter, and the micro-actuating device.

2. The lever mechanism of claim 1, wherein the first power transmitter has one end connected to the second power transmitter and, the opposite end connected to a fixed unit, the displacement of the one end is larger than the displacement of the opposite end when the first power transmitter transmits power generated by the power generator while being connected to the power generator between the center of the first power transmitter and the fixed unit, which is connected to the opposite end.

3. The lever mechanism of claim 2, wherein the second power transmitter has one end connected to the fixed unit, and the opposite end connected to the micro-actuating device, the displacement of one end, which is connected to the first power transmitter, is larger than the displacement of the opposite end when the second power transmitter transmits power transmitted from the first power generator while being connected to the first power transmitter between the center of the second power transmitter and the opposite end.

4. The lever mechanism of claim 1, wherein the hinge makes an elastic knuckle joint motion.

5. The lever mechanism of claim 1, wherein the power generator generates power by an electrostatic force, a magnetic fore or a piezoelectric force.

6. The lever mechanism of claim 1, further comprising levers installed between the first and second power transmitters, the levers for helping the smooth operations of the first and second power transmitters.

7. The lever mechanism of claim 1 further comprising levers installed between the second power transmitter and the micro-actuating device, the levers for helping the smooth operations of the second power transmitter and the micro-actuating device.

8. The lever mechanism of claim 4, wherein the displacements of the hinges and the lever are increased due to their resonance movement.

9. The lever mechanism of claim 6, wherein the displacements of the hinges and the lever are increased due to their resonance movement.

10. The lever mechanism of claim 7, wherein the displacements of the hinges and the lever are increased due to their resonance movement.

11. A lever mechanism for increasing the displacement of a micro-actuating device, the lever mechanism comprising:
a media for recording and reproducing data;
at least one second power transmitter connected to two edges of one side and opposite side of the media;
at least one first power transmitter for transmitting power to the second power transmitter(s);
power generators for generating power to be transmitted to the first power transmitter(s) in a predetermined direction; and
at least one hinge installed among the power generators, the first and second power transmitters, and the media.

12. The lever mechanism of claim 11, wherein the hinge makes an elastic knuckle joint motion.

13. The lever mechanism of claim 11 further comprising:
a first lever installed between the first power transmitter and the second power transmitter, the first lever for helping the smooth operations of the first and second power transmitters.

14. The lever mechanism of claim 9, wherein the displacements of the hinges and the first and second levers are increased due to their resonance movement.

15. The lever mechanism of claim 10, wherein the displacements of the hinges and the first and second levers are increased due to their resonance movement.

16. The lever mechanism of claim 11, wherein the displacements of the hinges and the first and second levers are increased due to their resonance movement.
